(19) United States
(12) Patent Application Publication
(10) Pub. No.: US 2003/0116173 A1
(43) Pub. Date: Jun. 26, 2003

(54) Process for electrolytically cleaning paste from a workpiece

(75) Inventors: James N, Humenik, LaGrangeville, NY (US); Tuyen Hong Nguyen, Poughkeepsie, NY (US); George R. Proto, LaGrangeville, NY (US); Demian M. Riccardi, Madison, WI (US); Krishna G. Sachdev, Hopewell Junction, NY (US); Krystyna W. Semkow, Poughquag, NY (US)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation

(21) Appl. No.: 10/026,239

(22) Filed: Dec. 21, 2001

(51) Int. Cl. B08B 3/02; B08B 3/12

(52) U.S. Cl. 134/1; 134/26; 134/34

(57) ABSTRACT

A process for cleaning paste from a workpiece, such as a screening mask, which includes the step of electrolytically contacting the workpiece with an aqueous solution containing 0.2 to 2 weight percent TMAH. As an optional prestep, the workpiece may be cleaned nonelectrolytically with an aqueous solution containing 0.2 to 2 weight percent TMAH.

### RELATED APPLICATION

This application is related to U.S. patent application Ser. No. ______ (attorney docket no. FIS9-2001-0260), entitled “APPARATUS FOR CLEANING RESIDUAL MATERIAL FROM AN ARTICLE”, filed even date herewith, the disclosure of which is incorporated by reference herein.

### BACKGROUND OF THE INVENTION

The present invention is directed to the cleaning of paste from a workpiece, and more particularly, is directed to the electrolytic cleaning of a workpiece, preferably a screening mask, utilizing tetra methyl ammonium hydroxide.

In the fabrication of multilayer ceramic substrates for the packaging of semiconductor devices, conductive metal patterns comprising wiring lines, vias, input/output pads and the like, are screened on individual ceramic greensheets through a screening mask. After screening, the greensheets are assembled and aligned, and laminated followed by a sintering operation to form a multilayer ceramic substrate. Fabrication techniques for such multilayer ceramic substrates, including design, screening equipment, and paste screening process are well known in the art.

However, advanced ground rule electronic packaging requires printing a closely spaced conductive metal pattern on the greensheets, and using a screening mask that has highly dense fine dimension etched features. It has been observed that such screening masks have the problem of paste entrapment in the mask features in addition to a surface coverage when the paste is screened to deposit the conductive metal pattern. This requires that the screening mask be completely and efficiently cleaned after one or more screening passes to eliminate, or at least minimize, the possibility of defects in subsequently screened metal patterns. Any defects in the screened conductive metal pattern replicates into the final product causing yield losses. Moreover, in automated processes for high volume production of multilayer ceramic substrates, it is also necessary that the speed of mask cleaning be compatible with the cycle time preset by the throughput requirement and other dependent operations.

Conductive pastes used in screening the conductive metal patterns comprise metal particles mixed with an organic or inorganic binder and solvent vehicle along with wetting agents, dispersants, surfactants, plasticizers, thickening agents, antioxidants and coloring agents, all of which are well known in the fabrication of electronic components.

Most commonly used conductive pastes in multilayer ceramic fabrication are based on copper, gold, nickel, tin, solder, molybdenum or tungsten metal powders dispersed in an organic polymer binder such as, for example, ethyl cellulose, polymethyl methacrylate, or polyvinyl butyral, in a high boiling point solvent vehicle.

Various processes have been proposed for cleaning screening masks. Sachdev et al. U.S. Pat. Nos. 6,277,799 and 6,280,527, the disclosures of which are incorporated by reference herein, disclose a particularly preferred process to clean the screening mask with a pressure spray of tetramethyl ammonium hydroxide (hereafter TMAH). While this process works well in practice, there is room for improvement in that it would be desirable to reduce the amount of TMAH that is used in the cleaning process as well as the time of the cleaning process.

Others have proposed electroclean processes for cleaning a variety of workpieces.

Hoffman, Jr. et al. U.S. Pat. No. 6,203,691, the disclosure of which is incorporated by reference herein, discloses an electrolytic method to electroclean by immersion or spraying a conductive body acting as a cathode to remove oxides or impurities. The electrolyte used is an aqueous solution of disodium phosphate and sodium bicarbonate having a pH between 7 and 9.

Riabkov et al. U.S. Pat. No. 5,981,084, the disclosure of which is incorporated by reference herein, discloses an electrolytic method to clean a conductive body acting as a cathode in a spray type cell in which an aqueous electrolyte is sprayed onto the body under pressure. The aqueous electrolyte comprises sodium carbonate, potassium carbonate, sodium chloride or sodium nitrate and may optionally contain a soluble salt of a suitable metal of which no examples are given.

Datta et al. U.S. Pat. No. 5,152,878, the disclosure of which is incorporated by reference herein, discloses an electrocleaning method to remove a metallic residue stain from a molybdenum mask. The electrolyte is comprised of phosphoric acid and glycerol.

Notwithstanding the above efforts in the prior art, there remains a need for an improved process for cleaning paste from screening masks and the like.

Accordingly, it is a purpose of the present invention to have an improved process for cleaning paste from screening masks and the like.

It is a further purpose of the present invention to have an improved process for cleaning paste from screening masks and the like wherein an aqueous cleaning agent is used.

It is yet another purpose of the present invention to have an improved process for cleaning paste from screening masks and the like that reduces the time of cleaning the screening masks while also reducing the amount of cleaning agent utilized.

These and other purposes of the present invention will become more apparent after considering the following description in conjunction with the accompanying drawings.

### BRIEF SUMMARY OF THE INVENTION

The purposes of the invention have been achieved by providing a process for cleaning paste residue from a workpiece comprising the step of electrolytically contacting the workpiece with an aqueous solution containing 0.2 to 2 weight percent TMAH.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a schematical representation of a first apparatus useful for practicing the present invention.

FIG. 2 is a schematical representation of a second apparatus useful for practicing the present invention.

### DETAILED DESCRIPTION OF THE INVENTION

The present invention is principally concerned with a method of removing screening paste from screening masks and ancillary equipment used in screening conductive paste patterns on ceramic greensheets in the manufacture of multilayer ceramic substrates. Moreover, the present invention is concerned with the cleaning of screening masks and ancillary equipment in high throughput multilayer ceramic substrate production.

The manufacturing of multilayer ceramic substrates typically employs the technique of screening a conductive pattern on a ceramic greensheet through a stencil mask using a variety of polymer-metal composite pastes to delineate the conductive pattern for the desired circuitry. In this process, some paste is left behind on the surface of the mask as well as inside the very small features of the screening mask. The paste entrapped in the mask features and on the surface of the mask must be removed if the mask is to be reused for the screening of the conductive paste. In the production environment where automated screening and mask cleaning processes are utilized, mask cleaning may be done after one or more screening passes, otherwise the paste on the surface of the mask and in the mask features can cause defects in subsequently screened conductive patterns.

The screening masks utilized may be, for example, molybdenum, nickel, copper or a combination of copper and nickel (e.g., copper plated nickel).

As mentioned previously, the pressure spraying of TMAH works very well in a production environment to clean the screening masks and ancillary equipment. However, there are at least three reasons why an improved cleaning method is desirable. First, it would be desirable to decrease the amount of time necessary for mask cleaning so as to increase the throughput of the screening apparatus. Second, the used TMAH must be cleaned and recycled or disposed of so it would be desirable to reduce the amount of TMAH used. Third, there are certain crevices or hidden spots which the sprayed TMAH can't reach.

Accordingly, the present inventors have proposed an electrolytic process for removing the paste from the screening masks and ancillary equipment. In the electrolytic process, the workpiece, i.e., the screening mask or ancillary equipment, is contacted with an aqueous solution containing TMAH in an electrolytic cell. The workpiece is made the cathode (−) while the spray nozzles (if the TMAH is to be sprayed), or a mesh or sheet (if the workpiece is immersed) are made the anode (+). The aqueous solution containing TMAH is the electrolyte. The concentration of the TMAH is 0.2 to 2 weight percent.

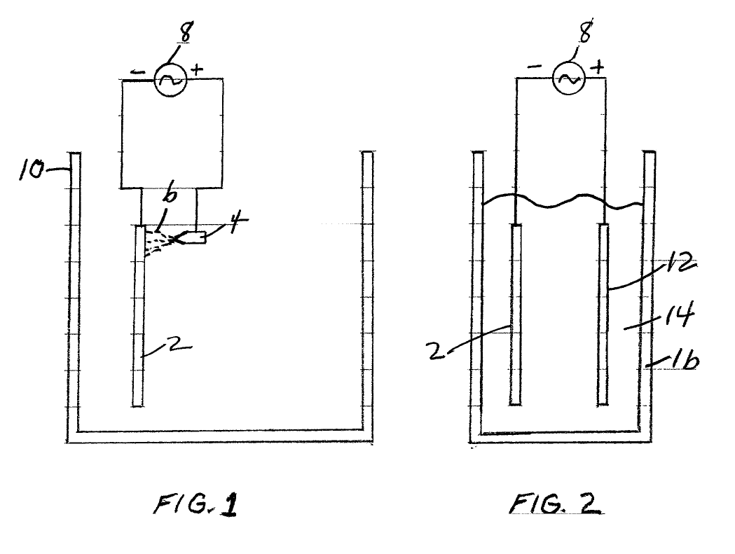

If the aqueous solution containing TMAH is to be sprayed, the nozzles have to be close enough and the spray has to be sufficient to maintain an electrical circuit between the spray nozzles and the workpiece. The present inventors believe that a distance of about 1 cm. or less is sufficient. A schematical representation of a first apparatus for practicing the present invention is illustrated in FIG. 1 where a workpiece 2 (e.g., a screening mask) having a paste thereon is contacted by spray 6 of an aqueous TMAH solution from spray apparatus 4. The workpiece 2 is the cathode (−) while the spraying apparatus 4 is the counter electrode or anode (+). A power supply 8 provides the current for the electrolytic process of the present invention. There will typically be a protective enclosure 10 to contain the spray 6. Further details on an apparatus for practicing the present invention can be elucidated from the above-noted RELATED APPLICATION.

Alternatively, as shown in FIG. 2, the workpiece 2 can be simply immersed in the aqueous TMAH solution 14 in a tank 16 and agitated if desired such as by ultrasonic or spray agitation.

The concentration of the TMAH in the aqueous solution is an important consideration. TMAH in a minimum amount of 0.2 weight percent should be sufficient for electrical conductivity while the upper limit of 2 weight percent should be sufficient for any cleaning activity. The present inventors have found that effective electrocleaning of the workpiece can occur when the concentration of TMAH in the aqueous solution is in the range of 0.4 to 0.5 weight percent and nominally 0.45 weight percent. In the prior art process of merely spraying the TMAH to clean the workpiece, it was found that the optimum amount of TMAH for cleaning copper or copper/nickel masks in the aqueous solution was 0.8 weight percent although molybdenum masks could be spray cleaned with an aqueous solution containing 0.4 to 0.5 weight percent TMAH. Thus, the electrolytic cleaning of the present invention is able to reduce the amount of TMAH present by almost 50% for at least some workpiece materials and all workpiece materials are more effectively cleaned with the electrolytic cleaning of the present invention.

The prior art process relied on the chemical reaction of the TMAH and the paste to break the bond of the paste to the workpiece. The paste was then swept away by the very strong mechanical action of a high pressure spray or ultrasonic agitation. While not wishing to be held to any particular theory, the present invention is believed to be an improvement over the prior art TMAH process in that hydrogen bubbles are evolved which scrub the workpiece and hydroxide ions are evolved during electrolytic cleaning which cause a local increase in the pH to thereby further facilitate the breaking of the bonds of the paste to the workpiece in addition to the chemical reaction of the TMAH and the paste. Further, there may be electrochemical reduction of surface oxides on the mask which further facilitates the breaking of the bond of the paste to the mask. The aqueous TMAH solution has a typical pH of about 13 which is locally raised during the electrocleaning of the workpiece.

Since the present process does not rely entirely on the cleaning action of TMAH with the paste, as well as any mechanical action that is present, to remove the paste, any paste residue in crevices or otherwise hidden in the workpiece features is removed by the present invention. Thus, the useful life of the workpiece is effectively extended.

The present invention can be used in conjunction with the prior art process of simply spraying an aqueous TMAH solution to clean the workpiece by mechanically removing any paste loosened by the TMAH. In this preferred embodiment of the present invention, an aqueous TMAH solution (0.2-2 weight percent TMAH at a temperature of 25-80° C., most preferably 70° C.) is applied without current to the workpiece to remove most of the paste. Application of the nonelectrolytically applied TMAH may be by immersion or spraying. Application of an electrolytic aqueous solution of TMAH would then be applied to finish the cleaning of the workpiece.

The nominal current density utilized in the present invention is about 100 mA/cm² but can actually vary between about 20 and 250 mA/cm². The current density is dependent on the particular paste used and the thickness of the paste.

It is preferred that the temperature of the aqueous solution be 25 to 80° C., and preferably 70° C. for maximum effectiveness of the aqueous solution.

In addition to conventional components such as a carrier solvent, surfactant, thickening agent and binder, which may be, for example, ethyl cellulose or polyvinyl butyral, the paste will usually also contain an inorganic material such as ceramic or glass particulates or a metallic material such as molybdenum, copper, tungsten, nickel, gold, palladium, platinum or silver. The present invention has been demonstrated to work effectively on pastes comprising a number of the foregoing materials including copper pastes, copper/nickel pastes, copper pastes with glass, copper/nickel pastes with glass, molybdenum pastes and tungsten pastes, all with ethyl cellulose as the binder. The solids content of the pastes will typically be 80 to 90% by weight.

The purposes of the present invention will become more apparent after reviewing the following Examples.

### EXAMPLES

In a first set of examples, copper-plated nickel masks coated with a paste containing about 80 weight % solids comprising about 50 volume % copper and about 50 volume % glass, and about 1 weight % of an ethyl cellulose binder plus conventional components as noted above were immersed in various TMAH concentrations of aqueous TMAH solutions at room temperature. The concentrations of TMAH varied from 0.2 to 0.8 weight percent in the solutions. The solutions were agitated by ultrasonic or spray (at about 30 psi from a nozzle having a single jet). A current density of 100 mA/cm² was applied to half of the samples and no current was applied to the remaining samples. The results are tabulated in Table 1. In every instance, those samples that were electrolytically cleaned required dramatically less time than those samples that were not electrolytically cleaned.

TABLE 1

| | TMAH | | | CURRENT |
|---|---|---|---|---|
| EXAMPLE | CONC., | | TIME, | DENSITY, |
| NO. | WEIGHT % | AGITATION | secs. | mA/cm² |
| 1 | 0.8 | Ultrasonic | 20 | 100 |
| 2 | 0.4 | Ultrasonic | 60 | 100 |
| 3 | 0.2 | Ultrasonic | 120 | 100 |
| 4 | 0.2 | Spray | 20 | 100 |
| 5 | 0.8 | Ultrasonic | 100 | 0 |
| 6 | 0.4 | Ultrasonic | 180 | 0 |
| 7 | 0.2 | Ultrasonic | 300 | 0 |
| 8 | 0.2 | Spray | 120 | 0 |

In a second set of examples, copper-plated nickel masks coated with a paste containing about 80 weight % solids comprising about 85 volume % molybdenum and 15 volume % glass, and about 2 weight % of an ethyl cellulose binder plus conventional components as noted above were spray cleaned by a brass spray nozzle (at a pressure of about 30 psi with a nozzle having a single jet) and an aqueous TMAH solution. The mask to nozzle distance was 1 cm. The concentration of the TMAH was either 0.2 or 0.4 weight percent. The temperature of the TMAH solution was 65° C. With half of the samples, a current density of 100 mA/cm² was applied whereas the other half of the samples had no current applied. The results are tabulated in Table 2. Again, in every instance, those samples that were electrolytically cleaned required dramatically less time than those samples that were not electrolytically cleaned. Further, the higher temperature in the second set of examples compared to the first set of examples resulted in shorter electrocleaning time.

TABLE 2

| | | | CURRENT |
|---|---|---|---|
| | TMAH CONC., | | DENSITY, |
| EXAMPLE NO. | WEIGHT % | TIME, secs. | mA/cm² |
| 9 | 0.4 | 6 | 100 |
| 10 | 0.2 | 10 | 100 |
| 11 | 0.4 | 40 | 0 |
| 12 | 0.2 | 60 | 0 |

In a third set of examples, molybdenum masks coated with the molybdenum paste in the above second set of examples were spray cleaned with an aqueous TMAH solution containing 0.45 weight percent TMAH at a temperature of 70° C. and a maximum voltage drop of 120V. A stainless steel nozzle having multiple jets was used with a mask to nozzle distance of 1 cm. The pressure of the TMAH spray was varied from 50 to 180 psi to study the effect on the current density. The results are tabulated in Table 3. As can be seen, the maximum current density occurs between 80 and 180 psi of pressure.

TABLE 3

| | TMAH PRESSURE, | CURRENT DENSITY, |
|---|---|---|
| EXAMPLE NO. | psi. | mA/cm² |
| 13 | 50 | 50 |
| 14 | 80 | 250 |
| 15 | 130 | 250 |
| 16 | 180 | 250 |

A fourth set of examples was prepared in the same manner as the third set of examples above except that the masks electrolytically cleaned were copper-plated nickel masks and the maximum voltage drop was 80V. The results are tabulated in Table 4. As can be seen, the maximum current density occurs at 180 psi.

TABLE 4

| | TMAH PRESSURE, | CURRENT DENSITY, |
|---|---|---|
| EXAMPLE NO. | psi. | mA/cm² |
| 17 | 20 | 50 |
| 18 | 50 | 150 |
| 19 | 80 | 220 |
| 20 | 130 | 220 |
| 21 | 180 | 250 |

In view of the above examples and the teaching herein, it has been found that the most preferred parameters of a 0.45 weight percent TMAH aqueous solution, at a temperature of 70° C., at a spray pressure of 180 psi and a current density of about 250 mA/cm2 were sufficient to clean all types of paste from molybdenum, nickel, copper and copper-plated screening masks.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A process for cleaning paste residue from a workpiece comprising the step of electrolytically contacting the workpiece with an aqueous solution containing 0.2 to 2 weight percent TMAH.

2. The process of claim 1 wherein the step of electrolytically contacting comprises spraying the workpiece with the aqueous solution.

3. The process of claim 1 wherein the step of electrolytically contacting comprises immersing the workpiece in the aqueous solution.

4. The process of claim 1 wherein the aqueous solution in the step of electrolytically contacting is maintained at a temperature of 25 to 80° C.

5. The process of claim 1 wherein the aqueous solution in the step of electrolytically contacting is maintained at a temperature of 70° C.

6. The process of claim 1 wherein the aqueous solution in the step of electrolytically contacting contains 0.4 to 0.5 weight percent TMAH.

7. The process of claim 1 further comprising the step, prior to the step of electrolytically contacting, of nonelectrolytically contacting the workpiece with an aqueous solution containing 0.2 to 2 weight percent TMAH.

8. The process of claim 7 wherein the step of nonelectrolytically contacting comprises spraying the workpiece with the aqueous solution.

9. The process of claim 7 wherein the step of nonelectrolytically contacting comprises immersing the workpiece in the aqueous solution.

10. The process of claim 7 wherein the aqueous solution in the step of nonelectrolytically contacting is maintained at a temperature of 25 to 80° C.

11. The process of claim 7 wherein the aqueous solution in the step of nonelectrolytically contacting is maintained at a temperature of 70° C.

12. The process of claim 1 wherein the workpiece is a screening mask.

13. The process of claim 1 wherein the paste comprises solder.

14. The process of claim 1 wherein the paste comprises at least one metal selected from the group consisting of molybdenum, copper, tungsten, nickel, gold, palladium, platinum and silver.

15. The process of claim 1 wherein the paste residue comprises an inorganic material selected from the group consisting of ceramic and glass.

16. The process of claim 1 wherein the paste comprises a polymeric binder.
